(19) United States
(12) Patent Application Publication
(10) Pub. No.: US 2015/0053638 A1
(43) Pub. Date: Feb. 26, 2015

(54) ANTI-TAMPERING COMPOSITION AND METHODS OF USE THEREFORE

(71) Applicant: SICPA HOLDING SA, Prilly (CH)

(72) Inventors: Martin SAROBE, Madrid (ES); Javier AMOR, Madrid (ES)

(21) Appl. No.: 14/466,182

(22) Filed: Aug. 22, 2014

Related U.S. Application Data
(60) Provisional application No. 61/869,361, filed on Aug. 23, 2013.

(30) Foreign Application Priority Data
Aug. 23, 2013 (EP) PCT/EP2013/067587

(51) Int. Cl. B65D 39/00; G01K 11/12; B05D 1/32; C09D 191/06; B05D 5/00

(52) U.S. Cl. CPC B65D 39/0005; C09D 191/06; B05D 5/00; B05D 1/32; G01K 11/12
USPC 215/364; 524/315; 524/299; 427/7; 116/201

(57) ABSTRACT

The instant disclosure relates to an anti-tampering composition for use with capsules and corks of a wine closure or other good or article, including a composition comprising a natural wax and an ink present in the natural wax, the composition being suitable for printing on various substrates and having high stability, and having at least 60 wt % natural wax based on the total weight of the composition. Also provided are methods of detecting exposure of an article or good to elevated temperatures, and methods of making an anti-tampering system for a good or article such as a beverage bottle capsule or cork.

### CROSS-REFERENCE TO RELATED APPLICATIONS

This application claims the benefit of U.S. Provisional Application No. 61/869,361, filed Aug. 23, 2013, and of PCT Application No. PCT/EP2013/067587, filed Aug. 23, 2013, the disclosures of which are incorporated by reference herein in their entireties.

### FIELD OF THE INVENTION

The present invention relates to the field of packaging and compositions for protecting articles such as beverage bottle capsules and corks against counterfeiting or tampering. The anti-tampering compositions of the present invention secure the article and/or any contents therein against tampering or counterfeiting attempts comprising, for example, exposure of the marked article to elevated temperatures. The present invention also relates to the use of markings or indicators that undergo irreversible color and/or structural changes upon tampering or a tampering attempt.

### BACKGROUND OF THE INVENTION

Wine is a popular beverage consumed worldwide, and wine sales across the globe account for billions of dollars per year. Wines vary by the type of grape used, where the grape is grown, and the manner in which the wine is produced. Wines differ not only in their taste, color, smell, and origin, but also in their market value.

Counterfeiting is a global problem, affecting consumers, manufacturers, as well as governments. In the case of wine fraud, inferior wines are passed off or sold to a customer, usually at a price higher than what the product is worth. For example, one form of fraud involves affixing counterfeit labels of expensive wines to bottles of less expensive wine. Another form of fraud involves heating a wine bottle with hot water or vapor to remove the capsule or cork, and then using the capsule, cork, and/or bottle for selling an inferior wine. In this way, counterfeiters may provide imitation products and/or take unfair advantage of the renown of a brand, designated origin, or trademark. Moreover, black market sales make it very difficult to track or trace fraudulent alcohol sales. Black market sales also impact government revenues by avoiding the collection of taxes on such transactions. Illicit wine and other counterfeit products may also cause sickness due to unknown, unrecognized, or harmful chemicals present in the imitation product.

Various solutions have also been developed in the field to counter these problems associated with tampering. These solutions include the incorporation of tamper evident structures or anti-tamper security structures which provide evidence or indication of tampering upon alteration or manipulation of the packaging.

US 2001/0044014, which is incorporated by reference herein in its entirety, discloses an irreversible heat-sensitive composition comprising a mixture of a granular or powdery heat-fusible substance having a melting point corresponding to a temperature to be recorded and a granular or powdery dyestuff diffusible into the fused heat-fusible substance through dispersion or dissolution. A substrate with the heat-sensitive indicator provided thereon (including a heat-sensitive ink) is further disclosed. However, heat reactive inks can have low stability, and thus can result in false positive indications of exposure to tampering attempts requiring high temperatures, even when exposure is limited to, for example, 45° C. (113° F.) over 2-3 days. This can be particularly problematic for transport of wine bottles to countries with very warm climates where high temperatures and high humidity over long periods of time can exceed the tolerance of the heat-sensitive composition. Moreover, bottles of wine must be protected for more than 4-6 years.

WO 2008/135586, which is incorporated by reference herein in its entirety, also discloses a security device for authentication of valuable goods. The security device comprises a material layer having a random pattern comprising micro/submicrostructures in the range of 20 nm to 20 μm in the shape of blobs, i.e., geometrical domains having worm-like shapes. However, the blob shapes are defined by a first and second polymer arranged within a first and second phase. The security device is made by providing a single phase solution containing at least a first and a second polymer within a solvent. When the solvent is removed during a demixing process, circular spots appear at random locations in the film, which spots originate from a phase separation of the polymers. A thin film is thereby obtained that includes a stochastic pattern comprising microstructures of different phases. After marking an article with such a material, the mark may be read with a dedicated reading device to obtain a digital reference description which is stored in a reference security database. To check the authenticity of an item, the same type of reading device is used as was used to create the reference representation. The stochastic mark is then compared to the one stored in the reference database, which reveals if the item is authentic or not.

US 2013/0014690, which is incorporated by reference herein in its entirety, discloses a temperature management indicator which is capable of indicating specific temperature ranges by reversible color changes. The disclosed temperature management indicator comprises a reversible temperature indicating member including reversible temperature indicating pigment particles devoid of mercury, the pigment particles being dispersed in a resin. It is further disclosed that an additional irreversible temperature indicating member may be arranged on an indicator base plate, the irreversible temperature indicating member including a thermofusible substance-absorptive base material or a thermofusible substance-permeable material.

There remains, however, a need to provide a solution that is easy to print on the article to be protected, visible to the unaided eye, and that will not require altering the original design of the good or article to be marked. There also remains a need to ensure such anti-tampering features can be printed on capsules or corks with best resistance and high heat reactivity, while maintaining a high level of security to guard against manipulation, alteration, or diversion of goods, articles, or packaging containing any valuable products.

### SUMMARY OF THE INVENTION

Accordingly, there is provided an anti-tampering composition for capsules and corks of a wine closure (e.g., for a tin wine capsule material layer). The composition may be printed in one or more layers on to a substrate. The composition may comprise a natural wax and an ink present in the natural wax, such that it acts as a security feature to provide an anti-tampering composition for protecting against counterfeiting. In accordance with aspects and/or embodiments, the security features have a high level of security and coding properties against forgery.

There is also provided a composition comprising: a natural wax comprising an ink which is present in the natural wax; and optionally a silicate derivative, the composition including at least 60 wt % natural wax and up to 40 wt % ink, based upon the weight of the composition.

There is also provided such a composition, wherein the natural wax comprises at least 60 wt % non-glyceride long-chain carboxylic acid esters based on the weight of the natural wax.

There is also provided such a composition, wherein the natural wax comprises at least 60 wt % esters selected from aliphatic esters and/or diesters of cinnamic acid based on the weight of the natural wax.

There is also provided such a composition, wherein the natural wax and the ink are each present in an amount sufficient to obtain an irreversible change in visible appearance of the composition when exposed to a temperature of 80° C. or higher.

There is also provided such a composition, wherein the ink forms an image and exposure of the composition to a temperature of 80° C. or higher changes the visible appearance of the image formed by the ink.

There is also provided such a composition, wherein the ink forms an image and exposure of the composition to a temperature of 80° C. or higher changes the configuration of the composition such that at least a part of the image formed by the ink is broken down, blemished, or no longer visible.

There is also provided such a composition, wherein said ink is selected from the group comprising ink-jet ink, optically variable ink, flexographic ink, conductive ink, and the like.

There is also provided such a composition, wherein the ink further comprises additives, pigments, optical variable pigments, dyes, flakes, water reactive chemical agents or viscosity modifier agents.

There is also provided a capsule or a cork comprising: a composition on at least a partial surface of the capsule or cork, the composition comprising a natural wax; an ink which is present in the natural wax; and optionally a silicate derivative, said composition including at least 60 wt % natural wax and up to 40 wt % ink, based upon the weight of the composition.

In addition to the above compositions, there is provided a method of detecting exposure to an elevated temperature comprising: visually observing an article comprising a composition, the composition comprising a natural wax, an ink present in the natural wax, and optionally a silicate derivative, said composition including at least 60 wt % natural wax and up to 40 wt % ink, based upon the weight of the composition; and detecting exposure of the article to at least a first temperature based on an irreversible change in appearance of the composition when observed at a second temperature below that of the first temperature.

There is also provided such a method, wherein the change in appearance is characterized by visible speckles or bubble-like structures.

There is also provided such a method, wherein the ink forms an image and the exposure is detected by a distortion in the visible appearance of the image.

There is also provided such a method, wherein the natural wax comprises at least 60 wt % non-glyceride long-chain carboxylic acid esters based on the weight of the natural wax.

There is also provided such a method, wherein the natural wax comprises at least 60 wt % esters selected from aliphatic esters and/or diesters of cinnamic acid based on the weight of the natural wax.

There is also provided a process of applying an anti-tampering composition to a substrate, comprising converting a natural wax from a solid state to a liquid state, mixing an ink, and optionally a silicate derivative, into the liquid natural wax to form an anti-tampering composition; and applying the anti-tampering composition via a screen printing process to the substrate.

There is also provided a use of an indicator composition for tamper-proofing an article, the indicator composition comprising: a natural wax which is present in an amount of at least 60 wt % of the indicator composition, an ink which is present in the natural wax in an amount up to 40 wt % of the indicator composition; and optionally at least one silicate derivative present in an amount up to 10 wt % of the indicator composition.

In another aspect, there is also provided a method of making an anti-tampering system for a beverage bottle capsule or cork, comprising: printing a composition on at least a partial surface of the capsule or cork, wherein the composition comprises a natural wax comprising at least 60 wt % esters selected from one or more of non-glyceride long-chain carboxylic acid esters, long-chain aliphatic esters, and cinnamic aliphatic diesters, and an ink present in the wax, and wherein the natural wax and the ink are each present in an amount sufficient to obtain a change in visible appearance of the composition when exposed to a temperature of 80° C. or higher.

There is also provided a method according to any one the above methods, wherein said ink is selected from the group comprising ink-jet ink, optically variable ink, flexographic ink, conductive ink, and the like.

### BRIEF DESCRIPTION OF THE DRAWINGS

FIG. 1 shows an anti-tampering composition comprising a natural wax having at least 60 wt % non-glyceride long-chain fatty acid esters based on the total weight of the natural wax after exposure to hot water. Exposure results in color change and in the presence of bubble-like structures.

FIG. 2 shows an anti-tampering composition of Example 2 before and after exposure to various elevated temperatures.

FIGS. 3A and 3B show an anti-tampering composition of Example 4 before (FIG. 3A) and after (FIG. 3B) exposure to various elevated temperatures.

### DETAILED DESCRIPTION OF THE INVENTION

The present compositions and methods provide a solution to the problems associated with counterfeiting as described above. There is provided, for example, an anti-tampering composition for capsules and corks of a wine closure or other article, good, or packaging therefor, which may be easily printed onto the article, good, or packaging to be marked, which is resistant to heat and humidity due to natural climate variation, and which provides evidence of tampering, for example, when exposed to elevated temperatures. There is also provided methods of manufacture and methods of use for such compositions.

As used herein, the singular forms “a,” “an,” and “the” include the plural reference unless the context clearly dictates otherwise. For example, reference to “an ink” would also mean that mixtures of one or more inks can be present unless specifically excluded.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

Unless otherwise stated, a reference to a compound or component includes the compound or component by itself, as well as in combination with other compounds or components, such as mixtures of compounds.

The various embodiments disclosed herein can be used separately and in various combinations unless specifically stated to the contrary.

### Compositions of the Invention

In one aspect, there is provided herein a composition comprising a natural wax. The natural wax may comprise an ink or pigment preparation and, optionally, other components such a silicate or silicate derivative, sodium bicarbonate, varnishes based on phenolic resins, and one or more vegetable or mineral oils.

The natural wax present in a composition of the present invention may be obtained from plants or animals or derived naturally from petroleum. The natural wax may also be obtained from fossilized substances such as lignite or coal. Generally, natural waxes comprise organic compounds such as long alkyl chains, including for example, fatty acids. The long alkyl chains may be 18-40, 20-38, or 22-36 carbons in length. The long alkyl chains may also be 22-38 carbons in length, 24-36, 26-32, or 28-30 carbons in length. Natural waxes are often composed of esters of fatty acids and long chain alcohols. Specific examples of natural waxes include beeswax, Montan wax, carnauba wax (Brazil wax, palm wax), Chinese wax, lanonlin (wool wax), shellac wax, spermaceti, bayberry wax, Candelilla wax, castor wax, esparto wax, Japan wax, Jojoba oil, ouricury wax, soy wax, ozocertite (earth wax), Peat waxes, ceresin waxes, paraffin wax, and petroleum jelly.

The natural wax may comprise at least 60 wt % esters based upon the total weight of the natural wax, the esters selected from one or more of non-glyceride long-chain carboxylic acid esters, long-chain aliphatic esters, and cinnamic aliphatic diesters. The aliphatic esters may comprise straight-chain acids with even-numbered carbon chains from C₂₄ to C₂₈, and straight-chain alcohols with even-numbered carbon chains from C₃₀ to C₃₄. The natural wax may also comprise alpha-hydroxy esters. The alpha-hydroxy esters may comprise straight-chain hydroxy acids with even-numbered C₂₂-C₂₈ carbon chains, straight-chain acids with even-numbered C₂₄″ C₂₋₈ carbon chains, straight-chain monohydric alcohols with even-numbered C₂₄-C₃₄ carbon chains, and dihydric alcohols with even-numbered C₂₄ to C₃₄ carbon chains. In another embodiment, the natural wax may comprise cinnamic aliphatic diesters. The cinnamic aliphatic diesters may comprise cinnamic acids such as methoxycinnamic acid, dihydric alcohols with even numbered C₂₄-C₃₄ carbon chains and/or diesters of 4-hydroxycinnamic acid. In an embodiment, a natural wax of the present invention may also comprise free acids (e.g., straight-chain acids with, for example, even-numbered carbon chains from C₂₄ to C₂₈), free alcohols (e.g., straight-chain alcohols with, for example, even-numbered carbon chains from C₃₀ to C₃₄), hydrocarbons (e.g., straight-chain odd-numbered carbon chains from C₂₇ to C₃₁), and resins.

A natural wax of the invention may be a solid or a liquid. Preferred natural waxes are solid at room temperature. The natural wax may have a melting point of 75-95° C., 84-94° C., 80-86° C. For example, a natural wax of the present invention may have a melting point of 75, 76, 77, 78, 79, 80, 81, 82, 83, 84, 85, 86, 87, 88, 89, 90, 91, 92, 93, or 94° C. or greater.

Preferably, a natural wax of the present invention may comprise at least 60 wt % non-glyceride long-chain carboxylic acid esters based upon the total weight of the natural wax. In another preferred embodiment, the natural wax may comprise one or more of aliphatic esters, diesters of 4-hydroxycinnamic acid, ω-hydroxycarboxylic acids, and fatty acid alcohols. In a particularly preferred embodiment, the natural wax may comprise at least 60 wt % esters selected from long-chain aliphatic esters and diesters of cinnamic acid, the wt % being based on the total weight of the natural wax.

The natural wax may be present in the composition in an amount that is at least 56-99 wt % of the anti-tampering composition, in an amount that is at least 57, 58, 59, or 60-90 wt % of the anti-tampering composition, or in an amount which is 60-80, 61-79, 62-78, 63-77, 64-76, 65-75 wt % based on the weight of the anti-tampering composition. Preferably, the natural wax may be present in the anti-tampering composition in an amount that is 66, 67, 68, 69, 70, 71, 72, 73, or 74 wt % based on the total weight of the anti-tampering composition.

The inks of the present invention are not particularly limited, and include ink-jet inks, oxidative paste inks, optically variable inks, and conductive inks. Any color ink may be used, including, for example, red, yellow, blue, black, and metallic colors. The ink may comprise SICPA OASIS® Ink (for the purpose of the invention SICPAOASIS® refers to an ink which contains chiral liquid crystal polymer flakes with color shifting properties); a heat-reactive ink which can change color at, for example, 60° C.; SICPASTAR® Ink (for the purpose of the invention SICPASTAR refers to an ink which contains interference pigments with color shifting properties); or a paste ink. In a preferred embodiment, the ink is present in the natural wax such that it forms an image, a logo or a pattern. Heat-reactive inks exhibiting high stability, for example, at temperatures above 60° C., are preferred. Exposure of the anti-tampering composition to a temperature of 70, 75, 80, 85, 90, or 95° C. or higher may change the visible appearance of the image formed by the ink.

Optically variable pigments (also referred to in the art as colorshifting or goniochromatic pigments) exhibit a viewing-angle or incidence-angle dependent color. For example, coatings or layers comprising optically variable pigment particles exhibit a colorshift upon variation of the viewing angle (e.g., from a viewing angle of about 90° with respect to the plane of the coating or layer, to a viewing angle of about 22.5° with respect to the plane of the coating or layer). In addition to the overt security provided by the colorshifting property of the optically variable pigment particles, which allows for easy detection, recognition and/or discrimination of high-value articles or goods from their possible counterfeits with the unaided human senses, the colorshifting property of the optically variable pigment particles may be used as a machine readable tool for the recognition of the high value documents or articles. Thus, the colorshifting properties of the optically variable pigment particles may simultaneously be used as a covert or semi-covert security feature in an authentication process wherein the optical (e.g, spectral) properties of the pigment particles are analyzed.

The optically variable ink composition according to the present invention comprises a plurality of optically variable pigment particles. Preferably, the plurality of optically variable pigment particles are selected from any one of thin film interference pigment particles, interference coated pigment particles, cholesteric liquid crystal pigment particles, and mixtures thereof. The optically variable pigment particles are preferably present in an amount from about 10 wt % to about 40 wt %, the weight percents being based on the total weight of the optically variable ink composition. The optically variable ink according to the present invention can comprises chiral liquid crystal precurors (nematic and cholesteric dopants) such as described in WO2012076533 or WO2009121605 or WO2010115879.

The ink may further comprise additives, pigments, optical variable pigments, dyes, flakes, water reactive chemical agents or viscosity modifier agents. Pigment preparations and/or inks may, for example, be produced with varnishes based on phenolic resins with vegetable and mineral oils, to provide the ink and/or anti-tampering composition with adhesion, color, opacity, and other rheological properties suitable for use as described herein. Pigment preparations and/or inks may, for example, comprise one or more of phenolic varnishes, alkyd resins, polyethylene/polytetrafluoroethylene (PE-PTFE), anti-dryers, organic pigments, and the like.

The ink or pigment preparation may be present in a composition of the invention in varying amounts, up to 40 wt % or more, wherein the wt % is based on the weight of the entire composition. For example, the ink may be present in an amount of 1-40%, 5-38%, 10-36%, 15-34%, 20-32%, 22-30%, 24-28%, etc. The ink may also be present in an amount that is 21, 23, 25, 27, 29, 31, 33, 35, 37, or 39 wt % based on the weight of the composition. The weight percent of the pigment particles should be high enough to permit observation of optical variation, an image, or a color, with the naked eye and low enough to allow the composition to convert to a liquid state from a solid state at a suitable temperature for printing or lamination.

Other components may optionally be added to a composition of the present invention. For example, a silicate derivative may be added to an anti-tampering composition in order to enhance the printability and or to have a better design when printing an image a logo or a pattern. The silicate derivative may include oxides of silicon, such as silicon dioxide, and the like. The silicate derivative may be present in the anti-tampering composition in an amount that is 0.1-10 wt % or higher. For example, a silicate derivative such as SiO₂ may be present in an amount which is 1-9 wt %, 2-8 wt %, 3, 4, 5, 6, or 7 wt % of the anti-tampering composition.

Sodium bicarbonate may also be present in the anti-tampering composition. For example, sodium bicarbonate may be present in an amount that represents 1-20 wt % of the anti-tampering composition. In a preferred embodiment, the sodium bicarbonate may comprise 2-12 wt %, 5-11 wt % or 7-10 wt % of the anti-tampering composition. The sodium bicarbonate may be dispersed with one or more of the pigments prior to mixing with the natural wax. The sodium bicarbonate may be added, for example, to a blending varnish and it can be disperse to reduce the particle size of sodium bicarbonate and increase the surface of reaction (example 2) or it can be mix without dispersion (example 3). Both formulation give a different reaction with the hot water at 85-90° C. and as consequence with different visual aspect after this.

The substrates for use with the anti-tampering composition are not particularly limited. For example, the anti-tampering composition may be applied to substrates comprising a metal (for example, tin), paper, cork, glass, plastic, and materials used in packing or beverage bottling. In a preferred embodiment, the present invention provides a capsule or a cork comprising: a composition on at least a partial surface of the capsule or cork, the composition comprising a natural wax; an ink which is present in the natural wax; and optionally a silicate derivative.

Methods of Making and Applying an Anti-Tampering Composition

The present invention provides methods of making an anti-tampering system for a beverage bottle capsule or cork, comprising, for example, printing a composition as described above on at least a partial surface of the capsule or cork. The natural wax may be heated and converted from solid state to a liquid state. For example, the natural wax in solid form may be heated to at or above 75, 76, 77, 78, 79, 80, or 81° C. to obtain the natural wax in a liquid state. The natural wax may also be heated to a temperature of 82, 83, 84, 85, 86, 87, 88, 89, 90, or 91-99° C. or higher. For example, the natural wax may also be heated to a temperature of 90-120° C. However, any temperature suitable for converting the natural wax from a solid to a liquid or for maintaining the natural wax in a liquid state may be used. The temperature may be adjusted depending upon the natural wax or waxes that are included in the composition and/or which are to be melted or converted to liquid form from a solid form. An ink as described above may then be added, along with other components as described above, to the composition, for example, by mixing, blending, stirring, or the like to obtain an anti-tampering composition.

The present invention also provides a process of applying an anti-tampering composition to a substrate, comprising converting a natural wax from a solid state to a liquid state, mixing an ink, and optionally one or more other components, such as a silicate derivative, into the liquid natural wax to form an anti-tampering composition; and applying the anti-tampering composition via a screen printing process to the substrate. For example, the anti-tampering composition may be prepared and applied in a closed compartment connected to a continuous recirculation system. In this way, the temperature of the composition remains higher than 75° C. or higher during printing and/or application. The temperature of the composition for printing may be, for example, 100-110° C. The composition remains liquid for printing on a substrate (for example, a capsule surface), and once the composition goes out from the closed compartment, it is immediately solidified and sticks to the substrate.

The method of printing is not particularly limited, and may be selected from any screen printing or lamination process. For example, the compositions of the invention may be printed by a silkscreen printing process with a metallic plate or a kind of “sizepress.” In various embodiments of the invention, the method of printing may comprise methods of printing with an ink selected from the group comprising ink-jet ink, optically variable ink, flexographic ink, conductive ink, and the like. Printing may also be performed at high temperatures, including for example, at or above 75, 76, 77, 78, 79, 80, or 81° C.

Uses and Advantages of the Anti-Tampering Composition and Related Methods

After printing, the anti-tampering composition remains stable, with a high opacity and adhesion to the substrate. The integrity and visible appearance of the printed composition is also highly resistant to manipulation that occurs in the normal course of manufacturing, application, packaging, transport, sale, and consumer handling. The printed composition is, for example, highly rub resistant, particularly when applied to a capsule or cork. Formulation may include light fast (resistance to light degradation) and/or heat resistant pigments. Moreover, compositions as described herein are in compliance with standard health and safety regulations such as Registration, Evaluation, Authorisation & restriction of CHemicals (REACH) and the Classification, Labelling, Packaging (CLP) Regulation. The use of dangerous substances may therefore be avoided.

Use of the present anti-tampering compositions, and articles or goods marked with the same, are not particularly limited. For example, the present invention provides use of an indicator composition for tamper-proofing an article, for indicating the presence of a counterfeit good or goods within otherwise intact or original packaging, and/or for deterring the fraudulent diversion or mislabeling of a good or article in commerce.

There is also provided an anti-tampering composition as described above, wherein the ink forms an image and exposure of the composition to a temperature of 70, 75, 80, 85, 90, or 95° C. or higher changes the visible appearance of the image formed by the ink.

There is also provided a method of detecting exposure to an elevated temperature comprising: visually observing an article comprising a composition, the composition comprising a natural wax, an ink present in the natural wax, and optionally a silicate derivative, said composition including at least 60 wt % natural wax and up to 40 wt % ink, based upon the weight of the composition; and detecting exposure of the article to at least a first temperature based on an irreversible change in appearance of the composition when observed at a second temperature below that of the first temperature.

There is also provided such a method, wherein the change in appearance is characterized by visible speckles or bubble-like structures.

There is also provided such a method, wherein the ink forms an image and the exposure is detected by a distortion in the visible appearance of the image.

There is also provided such a method, wherein the natural wax comprises at least 60 wt % non-glyceride long-chain carboxylic acid esters based on the total weight of the natural wax.

There is also provided such a method, wherein the natural wax comprises one or more of aliphatic esters, diesters of 4-hydroxycinnamic acid, ω-hydroxycarboxylic acids, and fatty acid alcohols.

There is also provided such a composition, wherein the ink forms an image and exposure of the composition to a temperature of 80° C. or higher changes the configuration of the composition such that at least a part of the image formed by the ink is broken down, blemished, or no longer visible. For example, prior to exposure to elevated temperatures, such as immersion in hot water, the anti-tampering composition may comprise an optically variable ink that changes depending on the vision angle. Exposure of the marked article to elevated temperatures, including for example, temperatures of 80-90° C., 85-90° C., and 90° C. or higher, may result in the disappearance of the ink present in the composition. Exposure of the marked article to elevated temperatures, including for example, from 70-85° C., 80-85° C., or higher may also indicate tampering by evidence of a color change or loss in optical activity of the composition. Exposure of a printed anti-tampering composition to other temperatures, including temperatures of 70-80° C., may not result in any visible change in appearance. However, such exposure may result in decreased stability of the composition. Such exposure may also result in a lower resistance of the composition to manipulation, rubbing, smearing, or blemishing. Such exposure may also result in lower resistance of the composition to disappearance of ink within the image or in a distortion of the image formed by the ink. For example, exposure to temperatures of 70-75° C. may alter the stability of the composition whereby any manipulation over the printed composition or contact with the printed composition causes easy ink detachment, smearing or smudging.

Exposure of the composition or article includes exposure to any number of possible environmental conditions including heat, humidity, water vapor, or gases. Exposure may, for example, include immersion of the composition or an article comprising the composition in water. For example, the inside of a capsule comprising a composition as described herein, the outside of such a capsule, or the whole capsule may be exposed. The exposure may in a preferred embodiment comprise exposure to water vapor or immersion in water. Tampering may be detected from exposure to such conditions for as little as 1, 1.5, 2.0, 2.5 or 3.0 minutes or longer. An indication of tampering may be more pronounced when more than one side of a capsule or other article comprising the composition is exposed to heat or other conditions as described herein. An indication of tampering may also be more pronounced with increasing exposure temperature and/or with increasing exposure times.

In another embodiment, exposure of the anti-tampering composition to elevated temperature results in structural changes that may or may not be visible. For example, exposure of anti-tampering composition to one or more temperatures above 70° C. (e.g., 80-100° C.) may result in the appearance of blemishes and/or bubble-like structures. The bubble-like structures appear with the exposure of the composition or an article comprising the composition as described herein and represent a random effect so that the bubbles are randomly distributed. The size of the bubble-like structures may range in size from 0.5 to 3 mm. When the structural changes are not visible by an unaided eye, a specific dedicated device known by one skilled in the art could be used, for example the antitampering solution could be made with a natural wax according to the present invention with an invisible (Infrared) optically variable ink. Exposure to elevated temperature resulting in a structural change may be observed with a device able to detect IR radiation.

As is evidenced by the above, the present invention provides anti-tampering compositions comprising a natural wax and an ink, wherein the natural wax and the ink are each present in an amount sufficient to obtain an irreversible change in visible appearance of the composition when exposed to elevated temperatures of, for example, 80° C. or higher. The present invention also provides anti-tampering compositions comprising a natural wax and an ink, wherein the natural wax and the ink are each present in an amount sufficient to obtain an irreversible change in structure of the composition, which may or may not be visible, when such a composition is exposed to elevated temperatures of 70° C. or higher. The structural changes may be in the form of visible bubbles, bubble-like structures, spots, or speckles which appear after exposure. The bubble like structures may further be used to identify the article. The structural changes may also take the form of blemishes that are apparent to the visible eye, or result in the visible or invisible breakdown of the composition, which breakdown may, for example, affect the resistance of the printed composition to manipulation.

### EXAMPLES

The present invention is explained in more detail with reference to the following examples without restricting the invention in any way.

### Example 1

A natural wax having at least 60 wt % non-glyceride long-chain carboxylic acid esters (based on the total weight of the natural wax) is used, the natural wax being a solid at room temperature. The natural wax is heated to over 85° C. to convert the wax from a solid to a liquid state. A 36% pigment preparation (based on the total weight of the composition) is then mixed with the liquid natural wax to form an anti-tampering composition:

TABLE 1
Example 1

| | Wt % |
|---|---|
| | (based on total weight |
| Component | of composition) |
| Wax (has at least 60 wt % non-glyceride | 64.00 |
| long-chain carboxylic acid esters) | |
| Phenolic varnish | 13.3 |
| Alkyd resin | 11.7 |
| PE-PTFE | 1.4 |
| Anti-dryer | 0.6 |
| Organic pigment (OVI, yellow coloring or | 9.00 |
| Interference) | |
| Total | 100 |

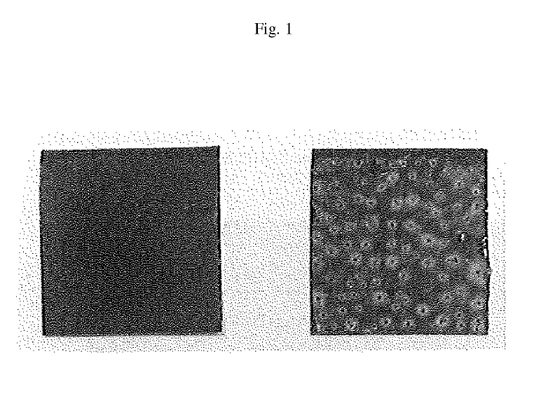

The anti-tamper solution is then quick cooled on tin material after printing at approximately 80° C. When the capsule is immersed in hot water (approximately 80-90° C.), the ink changes its appearance (FIG. 1).

### Examples 2-4

Another example relates to a composition comprising a natural wax having at least 60 wt % aliphatic esters and diesters of cinnamic acid, the wt % being based on the total weight of the wax. As with Example 1, the natural wax is a solid at room temperature. Accordingly, the natural wax is heated to a temperature of 90° C. to 120° C. to convert the wax from a solid to a liquid state. A pigment preparation is then mixed with the liquid natural wax, as are sodium bicarbonate, and SiO₂ to form the following anti-tampering compositions:

TABLE 2

| | Example 2 | Example 3 | Example 4 |
|---|---|---|---|
| Component | wt % - based on the total weight of the composition | | |
| Natural wax | 56.8 | 66.5 | 62 |
| Secureshift Scarlet | | 10 | 11.5 |
| (OVP) | | | |
| Yellow offset | 24.5 | | |
| Transp. White | | 14 | 14 |
| Offset | | | |
| SiO₂ | 2.5 | 2.8 | 2.8 |
| NaHCO₃ | 16.2 | 7 | 9.5 |
| Total | 100 | 100.3 | 99.8 |

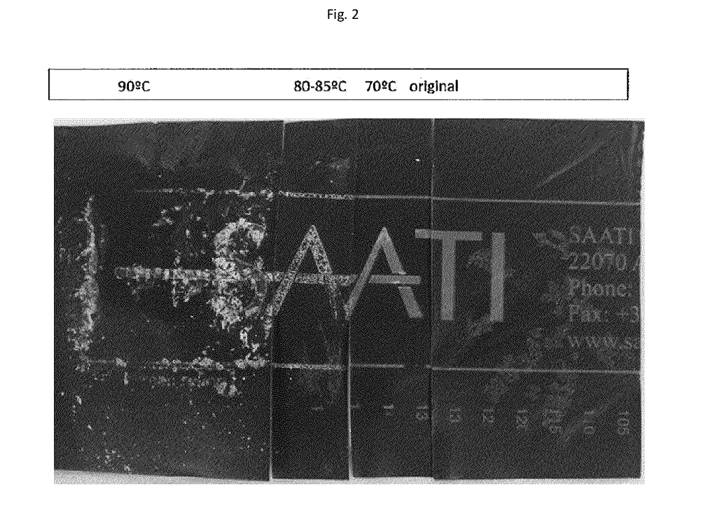

The anti-tampering compositions of Examples 2-4 are then printed onto a substrate at a temperature of 90-120° C. When an anti-tamper composition of Example 2 is printed on a tin substrate at a temperature of 100-110° C. with a silk screen process, the printability and rub-resistance of the resulting product are good. When the tin substrate having the applied composition is exposed to water temperatures ranging from 70° C. to 90° C. for two minutes, the anti-tamper composition changes (FIG. 2). For example, at 85° C. there is an appreciable change in the appearance of the composition. At 90° C. the composition is blemished, and the ink completely disappears. Even at a temperature of 80° C., although the change with the naked eye is slight, any manipulation over the capsule causes easy ink detachment. When a tin capsule printed with the same composition is incorporated into a wine bottle and exposed to a temperature about 90° or above for two minutes, no bubble-like structures may be formed or may be apparent, but the ink is easily released.

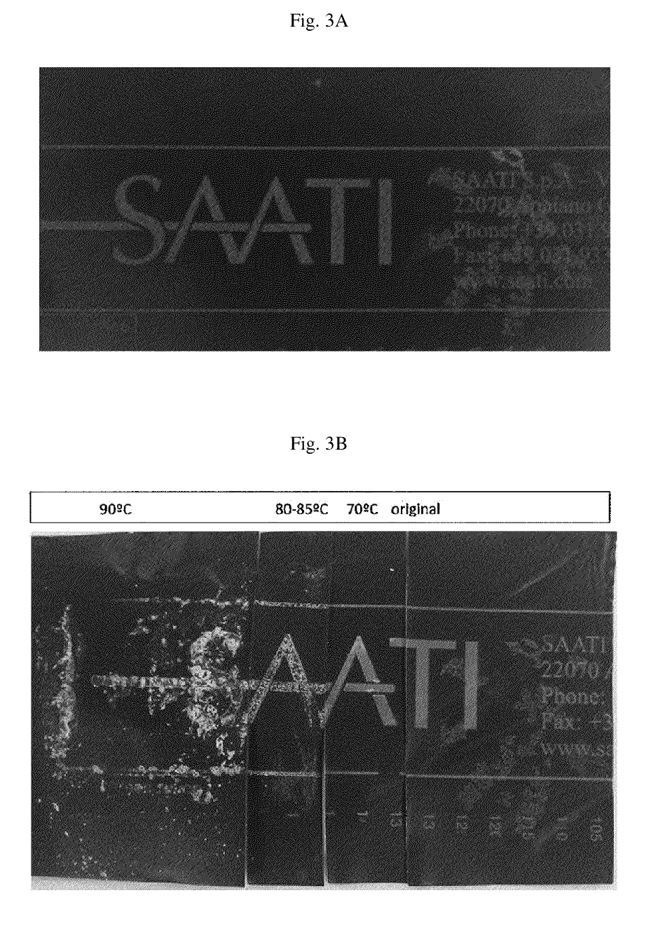

Exposure of the composition of Example 4 to hot water shows additional features and aspects of the invention. By way of another example, the composition of Example 4, which comprises an optically variable ink and higher rub resistance properties, is printed onto a tin substrate via a silk screen process at a temperature of 100-110° C. Exposure of the composition to temperatures ranging from 70° C. to 90° C. for two minutes shows visible changes which occur at increasing temperatures. FIG. 3A shows an image formed in the composition prior to exposure. FIG. 3B shows the original printed composition as well as sections exposed to water temperatures ranging from 70° C. to 90° C. Prior to water exposure, the optically variable ink changes color from magenta to gold depending on the vision angle. At a temperature of 90° C., the ink quickly disappears and blemishes and bubble-like structures are visible. Between 80-85° C. there is a color change from magenta to white, with an accompanying loss in optical activity. The printed composition resists changes to visible appearance and manipulation at exposure to 70° C. Color changes as described above, as well as the loss in optical activity described above, are also observed when a tin capsule comprising such a composition is incorporated into a wine bottle, and the wine bottle is subjected to the same exposure conditions.

The particulars shown herein are by way of example and for purposes of illustrative discussion of embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

1. A composition comprising:
a natural wax comprising
an ink which is present in the natural wax; and
optionally a silicate derivative,
said composition including at least 60 wt % natural wax and up to 40 wt % ink, based upon the weight of the composition.

2. The composition of claim 1, wherein the natural wax comprises at least 60 wt % non-glyceride long-chain carboxylic acid esters based upon the weight of the natural wax.

3. The composition according to claim 1, wherein the natural wax comprises at least 60 wt % esters selected from aliphatic esters and/or diesters of cinnamic acid based upon the weight of the natural wax.

4. The composition according to claim 1, wherein the natural wax and the ink are each present in an amount sufficient to obtain an irreversible change in visible appearance of the composition when exposed to a temperature of 80° C. or higher.

5. The composition of claim 4, wherein the ink forms an image and exposure of the composition to a temperature of 80° C. or higher changes the visible appearance of the image formed by the ink.

6. The composition of claim 4, wherein the ink forms an image and exposure of the composition to a temperature of 80° C. or higher changes the configuration of the composition such that at least a part of the image formed by the ink is broken down, blemished, or no longer visible.

7. The composition according to claim 1, wherein said ink is selected from ink-jet ink, optically variable ink, flexographic ink, or conductive ink.

8. The composition according to claim 1, wherein the ink further comprises additives, pigments, optical variable pigments, dyes, flakes, water reactive chemical agents or viscosity modifier agents.

9. A capsule or a cork comprising:
a composition on at least a partial surface of the capsule or cork, the composition comprising
a natural wax;
an ink which is present in the natural wax; and
optionally a silicate derivative,
said composition including at least 60 wt % natural wax and up to 40 wt % ink, based upon the weight of the composition.

10. A capsule or a cork according to claim 9 wherein the natural wax comprises at least 60 wt % non-glyceride long-chain carboxylic acid esters based upon the weight of the natural wax.

11. A method of detecting exposure to an elevated temperature comprising:
visually observing an article comprising a composition, the composition comprising a natural wax, an ink present in the natural wax, and optionally a silicate derivative, said composition including at least 60 wt % natural wax and up to 40 wt % ink, based upon the weight of the composition; and
detecting exposure of the article to at least a first temperature based on an irreversible change in appearance of the composition when observed at a second temperature below that of the first temperature.

12. A method of detecting exposure to an elevated temperature according to claim 11, wherein the wherein the ink is selected from ink-jet ink, optically variable ink, flexographic ink, or conductive ink.

13. The method according to claim 11, wherein the change in appearance is characterized by visible speckles or bubble-like structures.

14. The method according to claim 11, wherein the ink forms an image and the exposure is detected by a distortion in the visible appearance of the image.

15. The method according to claim 11, wherein the natural wax comprises at least 60 wt % non-glyceride long-chain carboxylic acid esters based upon the total weight of the natural wax.

16. The method according to claim 11, wherein the natural wax comprises at least 60 wt % esters selected from aliphatic esters and/or diesters of cinnamic acid based upon the weight of the natural wax.

17. A process of applying an anti-tampering composition to a substrate, comprising:
converting a natural wax from a solid state to a liquid state,
mixing an ink, and optionally a silicate derivative, into the liquid natural wax to form an anti-tampering composition; and
applying the anti-tampering composition via a screen printing process to the substrate.

18. A method of making an anti-tampering system for a beverage bottle capsule or cork, comprising:
printing a composition on at least a partial surface of the capsule or cork,
wherein the composition comprises a natural wax having at least 60 wt % esters selected from one or more of non-glyceride long-chain carboxylic acid esters, long-chain aliphatic esters, and cinnamic aliphatic diesters, and an ink present in the wax, and
wherein the natural wax and the ink are each present in an amount sufficient to obtain a change in visible appearance of the composition when exposed to a temperature of 80° C. or higher.

19. The method according to claim 12, wherein said ink is selected from ink-jet ink, optically variable ink, flexographic ink, or conductive ink.

20. A tamper-proof article including an indicator composition, the indicator composition comprising:
a natural wax which is present in an amount of at least 60 wt % of the indicator composition,
an ink which is present in the natural wax in an amount up to 40 wt % of the indicator composition; and
optionally at least one silicate derivative present in an amount up to 10 wt % of the indicator composition.
